(19) United States
(12) Patent Application Publication
(10) Pub. No.: US 2014/0308980 A1
(43) Pub. Date: Oct. 16, 2014

(54) CONTEXT ENABLED SURVEYS FOR TARGETED SURVEYS

(71) Applicant: Nokia Corporation, Espoo (FI)

(72) Inventors: Huanhuan Cao, Beijing (CN); Jilei Tian, Beijing (CN)

(21) Appl. No.: 14/355,018

(22) PCT Filed: Oct. 31, 2011
(86) PCT No.: PCT/CN2011/081556

§ 371 Date: Jun. 23, 2014

(51) Int. Cl. H04W 4/02

(52) U.S. Cl. CPC H04W 4/02
USPC 455/456.3

(57) ABSTRACT

Example approach is provided for surveys. An example method may include monitoring a location of a user equipment of a public land mobile network to determine when the monitored location corresponds to a survey trigger corresponding to a survey served by a server; sending to the server a request for content of the survey, when the monitored location corresponds to the survey trigger; and receiving, in response to the request, the content of the survey selected in accordance with a context derived from at least the monitored location. Furthermore, the location may include the user's general situation as a survey trigger condition to enable survey selection.

### FIELD

The subject matter described herein relates to surveys.

### BACKGROUND

Surveys have become commonplace today as entities, such as businesses, politicians, and governments, frequently conduct surveys. A typical survey may pose a question to elicit a response. The response may then be processed by the entity conducting the survey. For example, a survey may include at least a question, and the response to the question may be processed/analyzed. Surveys can be valuable to businesses because surveys allow the businesses to better understand the needs of its customers and thus sell more product or service to those customers. In short, surveys are a useful tool in business.

### SUMMARY

Methods and apparatus, including computer program products, are provided for surveys enabled by context. For some example embodiments, there is provided a method. The method may include monitoring a location of a user equipment of a public land mobile network to determine when the monitored location corresponds to a survey trigger corresponding to a survey served by a server; sending to the server a request for content of the survey, when the monitored location corresponds to the survey trigger; and receiving, in response to the request, the content of the survey selected in accordance with a context derived from at least the monitored location.

In some variations of some of the embodiments disclosed herein, one or more of the following may be included. The user equipment may present the received content of the survey corresponding to the context. The survey trigger may comprise at least one of a survey identifier and the location. The user equipment may receive a plurality of survey triggers representative of locations to be monitored by the user equipment. The user equipment may store a plurality of survey triggers representative of locations to be monitored by the user equipment. The user equipment may send the request for the content of the survey, when the monitored location is at least one of at or near the location mapped to the survey trigger. The request may comprise at least one of the survey trigger, a survey identifier, and the monitored location of the user equipment. The context may be determined semantically based on at least the monitored location of the user equipment. The content may comprise at least one of a question and a reward. The user equipment may register with the server to obtain surveys based on the context of the user equipment. The monitoring may further include receiving, at the user equipment, information representative of the location of the user equipment. For various example embodiments, the following may be applicable: an apparatus comprising means for performing a method of any of claims 1-11; wherein the apparatus comprises a user equipment; and a computer-readable storage medium carrying one or more sequences of one or more instructions which, when executed by one or more processors, cause an apparatus to perform at least a method of any of claims 1-11.

For some example embodiments, there is also provided a method. The method may include providing to a user equipment one or more survey triggers to enable the user equipment to monitor one or more locations associated with the one or more survey triggers; receiving, from the user equipment, a request for content of a survey triggered by at least one of the one or more survey triggers, the request comprising at least a monitored location of the user equipment; determining, based on at least the monitored location, a context for the received request; and sending, in response to the received request, the survey to the user equipment, the survey determined based on at least the determined context.

In some variations of some of the embodiments disclosed herein, one or more of the following may be included. At least the survey may be stored and mapped to the context. The one or more survey triggers may comprise at least one of a survey identifier and a location. The survey may comprise at least one question. The survey may comprise at least one reward. The context may be determined as a semantic context of the user equipment. The user equipment may be registered to obtain surveys based on the context of the user equipment. For various example embodiments, the following may be applicable: an apparatus comprising means for performing a method of any of claims 15-21; wherein the apparatus comprises a server; and a computer-readable storage medium carrying one or more sequences of one or more instructions which, when executed by one or more processors, cause an apparatus to perform at least a method of any of claims 15-21.

For some example embodiments, there is also provided an apparatus. The apparatus may comprise at least one processor and at least one memory including code which when executed by the at least one processor provides operations comprising: monitoring a location of the apparatus comprising a user equipment of a public land mobile network to determine when the monitored location corresponds to a survey trigger corresponding to a survey served by a server; sending to the server a request for content of the survey, when the monitored location corresponds to the survey trigger; and receiving, in response to the request, the content of the survey selected in accordance with a context derived from at least the monitored location.

For some example embodiments, there is also provided an apparatus. The apparatus may comprise at least one processor and at least one memory including code which when executed by the at least one processor provides operations comprising: providing to a user equipment one or more survey triggers to enable the user equipment to monitor one or more locations associated with the one or more survey triggers; receiving, from the user equipment, a request for content of a survey triggered by at least one of the one or more survey triggers, the request comprising at least a monitored location of the user equipment; determining, based on at least the monitored location, a context for the received request; and sending, in response to the received request, the survey to the user equipment, the survey determined based on at least the determined context.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1A depicts a block diagram of a survey server in accordance with some exemplary embodiments;

FIG. 1B depicts a map with a plurality of locations at which a survey may be presented at a user interface in accordance with some exemplary embodiments;

FIG. 1C depicts another block diagram of a survey server in accordance with some exemplary embodiments;

FIG. 2 depicts an example of a process for presenting surveys at a user equipment in accordance with some exemplary embodiments;

FIG. 3 depicts an example of a process for providing surveys to user equipment in accordance with some exemplary embodiments;

FIG. 4 depicts an example of user equipment in accordance with some exemplary embodiments; and

FIG. 5 depicts an example of a server in accordance with some exemplary embodiments.

Like labels are used to refer to same or similar items in the drawings.

### DETAILED DESCRIPTION

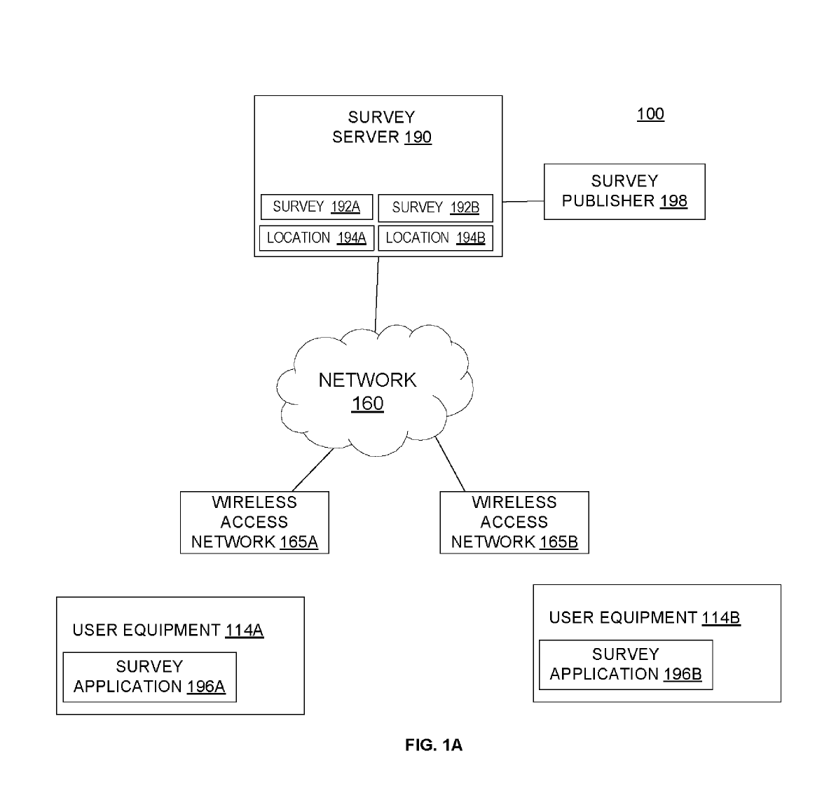

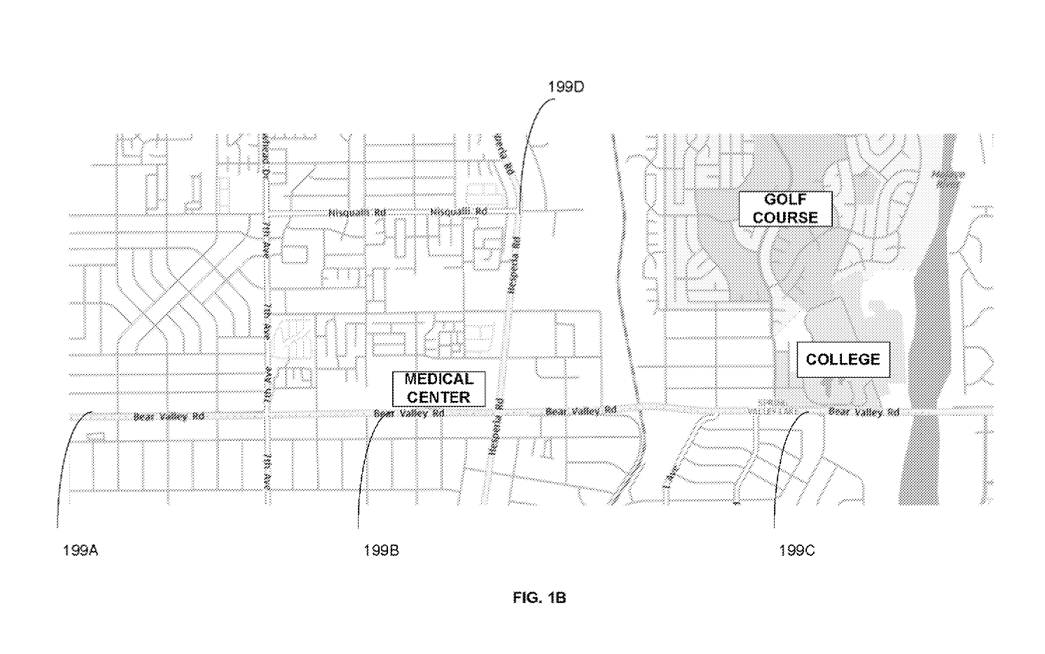

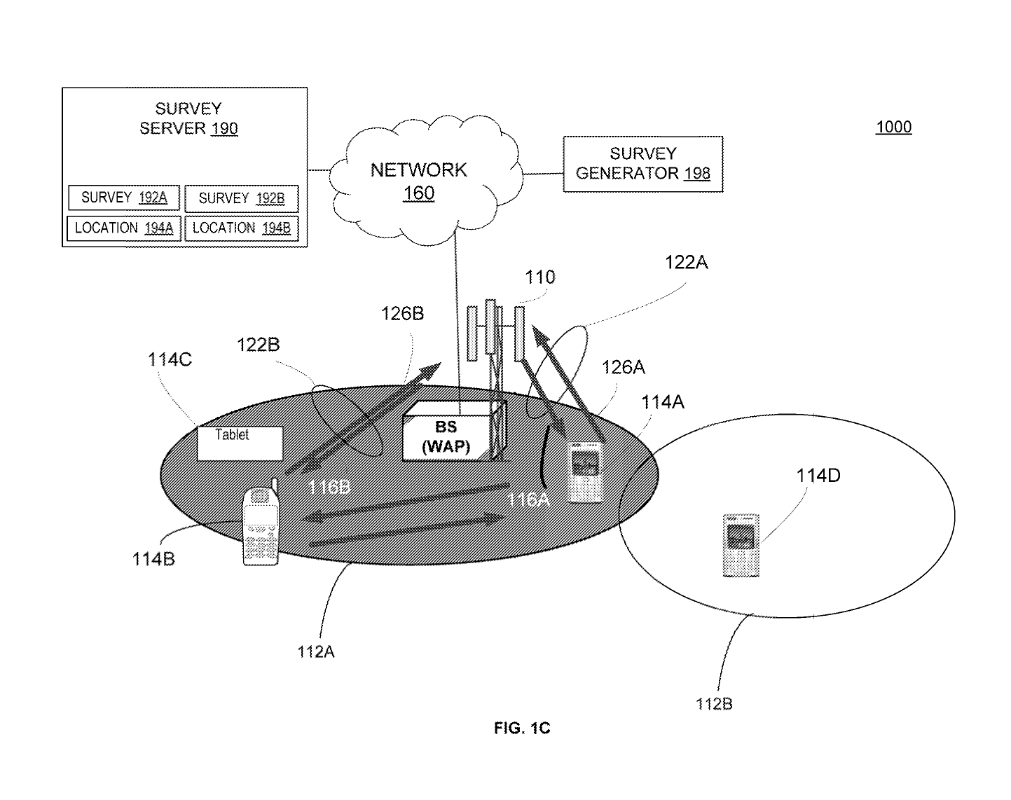

FIG. 1A is a simplified functional block diagram of a system 100 in accordance with some exemplary embodiments. The system 100 may include at least one server, such as survey server 190, configured to provide surveys to mobile wireless user equipment based on context, such as a location of the mobile wireless user equipment. Before providing a detailed description of FIG. 1A, the following provides a brief description of an exemplary implementation of survey server 190.

Survey server 190 may include one or more surveys, such as surveys 192A-B, and each of the surveys may be configured with location information 194A-B. For example, survey 192A may relate to a certain topic, such as cosmetic procedures (e.g., eyelifts, collagen treatments, and the like). Moreover, the survey 192A may include location information 194A configured to trigger, when user equipment 114A is in one or more specific locations, the survey 192A to be presented at a user interface of user equipment 114A. Returning to the previous cosmetic procedure example, when the location of user equipment 114A is monitored and a specific location is detected, such as near a clinic offering cosmetic procedures, the survey server 190 may provide to user equipment 114A the survey 192A corresponding to cosmetic procedures, so that the survey 192A may be presented at a user interface of user equipment 114A. In this example, the survey 192A is enabled by the context of the user equipment 114A being near, or at, the location corresponding to the location information 194A (which in this example represents a clinic offering cosmetic procedures).

In some exemplary embodiments, the surveys 192A-B may pose one or more questions, the answers to which may be gathered for subsequent analysis by the survey server 190. In some exemplary embodiments, the surveys may also be configured to include a reward. For example, the surveys 192A-B may each include a reward, such as for example an incentive, a coupon, a discount, and the like, when the survey 192A-B is completed at user equipment 114A.

In some exemplary embodiments, the survey server 190 may be configured to allow a survey publisher 198 to develop surveys 192A-B and/or upload surveys 192A-B. Moreover, the surveys 192A-B may each be associated with location information 194A-B, which triggers a corresponding survey 192A-B to be presented at a user interface of user equipment 114A. For example, location information 194B may define a location such that when user equipment 114A is at, near, or in a location corresponding to location information 194B, the survey 192B is presented at a user interface of user equipment 114A. The location information 194B may be configured as a point, a region, a street, a neighborhood, a city, a state, a latitude and longitude, global positioning system information, a cell identifier, and/or any other information representative of location.

Table 1 depicts examples of surveys, which may be served by survey server 190 to user equipment, such as user equipment 114A. In the example of Table 1, the first survey includes a survey identifier, 001, to identify the survey within system 100, survey content regarding cosmetic procedures, and location information representative of where the survey should be presented (e.g., when to trigger presentation of the survey). Although the location is depicted as a cell identifier, the location information may be implemented in other ways as noted above.

TABLE 1

| Survey | | Location | Location |
|---|---|---|---|
| Identifier | Survey Content | Information | Information |
| 001 | Do you use BOTOX? | Cell ID = | Cell ID = |
| | If so, answer the | 36247169 | 36247180 |
| | survey to get a 10% | | |
| | discount at Clinic X. | | |
| 002 | Do you need a | Cell ID = | Cell ID = |
| | student loan? | 36247170 | 36248000 |
| 003 | Do you play golf? | GPS | GPS |
| | Here is a discount | coordinates | coordinates |
| | on green fees? | XXXXX, | XXXXX1, |
| | | YYYY | YYYY1 |

In some exemplary embodiments, the system 100 may include a survey publisher 198. The survey publisher 198 may be configured to allow the development of surveys and/or uploading of surveys into survey server 190. The survey publisher 198 may also gather data obtained from surveys, analyze data gathered from surveys, and/or manage surveys including any rewards included in the surveys.

In some exemplary embodiments, the survey server 190 may be coupled to a network 160, which may be further coupled to wireless access networks 165A-B. For example, network 160 may include one or more networks, such as the Internet, access to the Internet Protocol (IP) Multimedia Subsystem, and backhaul access to network elements of the public land mobile network.

The wireless access networks 165A-B may, in some exemplary embodiments, represent wireless networks. For example, the wireless access networks 165A-B may provide coverage areas served by base stations of a public land mobile network, although other types of wireless networks, such as Wi-Fi networks and Wi-Fi wireless access points may be implemented as well.

The user equipment, such as user equipment 114A-B, may be implemented as a mobile wireless device, although at any given time the user equipment may be stationary as well. The user equipment may be referred to as, for example, devices, mobile stations, mobile units, subscriber stations, wireless terminals, terminals, tablets, and/or any other wireless device. Moreover, the user equipment may also be implemented as, for example, a wireless handheld device, a wireless plug-in accessory, or the like. For example, the user equipment may take the form of a wireless phone, a computer with a wireless connection to a network, or the like. In some instances, the user equipment may include one or more of the following: at least one processor, at least one computer-readable storage medium (e.g., memory, storage, and the like), a user interface, a radio access mechanism, and survey applications 196A-B.

The survey application 196A-B may be implemented as an application, a plug-in, an applet, and/or incorporated into another application, such as for example, a social networking application. Moreover, the survey application may present the survey at a user interface of the user equipment based on location information. For example, when a survey, such as survey 192A is stored in survey server 190, it is configured with location information 194A which may trigger the survey 192A to be presented at the user interface of user equipment 114A.

In some exemplary embodiments, survey server 190 may pre-load the survey application 196A/user equipment 114A with location information 194A and a survey identifier representing survey 192A. The survey application 196A may monitor (e.g., track) the location(s) of user equipment 114A and when a location trigger is satisfied because the user equipment is near, or at, the location corresponding to the location information 194A, the survey application 196A requests the contents of survey 192A from survey server 190 to enable presentation of the contents of survey 192A at the user interface of user equipment 114A. In some exemplary embodiments, the monitoring of location may include monitoring the user equipment's current situation. For example, the monitoring location may include determining that a user is at a concert based on audio information gathered at the user equipment or determining that a user is on a bus based on processing the motion data of the user equipment. In both of these examples, the monitored location is not a specific latitude or longitude but a general user context (e.g., a bus or a concert). This general user context may correspond to a survey which can be served to the user equipment.

FIG. 1B depicts a map including locations 199A-D to further illustrate an example implementation of the survey application 196A. For example, the survey application 196A may be pre-loaded with survey identifiers 001-003, as described above with respect to Table 1. The location information 194A-B, such as cell identifiers, latitude and longitude, global positioning system information, street names, neighborhood names, city names, and the like, may also be pre-loaded into survey application 196A (or memory at user equipment 114A). The survey application 196A may then monitor the position of user equipment 114A and, when the user equipment moves from location 199A to location 199B, the context corresponding to location 199B may trigger survey identifier 001, which may correspond to a cosmetics survey 192A. When this is the case, survey application 196A may request the contents of survey 192A and then present the survey contents for survey 192A at a user interface of user equipment 114A. When the user equipment 114A moves to location 199C (which is near a college), the context corresponding to location 199C may trigger survey identifier 002, which corresponds to a survey for a student loan. Furthermore, as the user equipment 114A moves to location 199D (which is near a golf course), the context corresponding to location 199D may trigger survey identifier 003, which is a survey corresponding to golf and includes a reward for discounted green fees. Although the previous examples described pre-loading the survey application 196A with the survey identifier and location information and, when triggered, subsequently loading the survey contents, in some exemplary embodiments, the survey contents (and/or a link to the content of the survey) and the location information may be sent at the outset to the user equipment 114A, so that when the location information is triggered, the survey application 196A can promptly present the survey at the user interface of user equipment 114A, without having to request the contents of the survey from survey server 190. Furthermore, the examples of Table 1 and FIG. 1B are only illustrative as other types of surveys, locations, and rewards may be implemented as well.

FIG. 1C depicts a system 1000 in accordance with some exemplary embodiments. The system 1000 includes some features similar to those described with respect to system 100, but further depicts an implementation with a public land mobile network.

Referring to FIG. 1C, the survey server 190 may be coupled via network 160 to a base station 110. The base station 110 may be capable of communicating with wireless devices, such as user equipment 114A-C within the coverage area 112A. In the example of FIG. 1C, user equipment 114D is not within the coverage area 112A, but instead within coverage area 112B, so user equipment 114D would be serviced by another base station.

The system 1000 may include access links, such as access links 122A-B, between the base station and the user equipment. The access links 122A-B may also include a downlink, such as downlinks 116A and 116B, for transmitting from the base station 110 to a corresponding user equipment. The access links 122A-B may also include an uplink, such as uplinks 126A and 126B, for transmitting from the user equipment to the base station.

In some implementations, the base station 110 may be configured as an evolved Node B (eNB) type base station consistent with standards, including the Long Term Evolution (LTE)/LTE-Advanced standards, and any subsequent additions or revisions to these and other 3GPP series of standards (collectively referred to as LTE standards), although the base station may be implemented in accordance with other standards and technologies as well. Although the base station 110 is described as an eNB base station, the base station 110 may be configured in other ways as well and include, for example, cellular base station transceiver subsystems, gateways, access points, radio frequency (RF) repeaters, frame repeaters, nodes, servers, web sites, and access to other networks. For example, base station 110 may have wired and/or wireless backhaul links including network/internet connections to other network nodes, such as other base stations, a radio network controller, a core network, a serving gateway, a mobility management entity, a serving GPRS (general packet radio service) support node, location servers, servers, web sites, and the like.

Moreover, although base station 110 is described as a cellular, eNB base station, base station 110 may also be implemented as a wireless access point, such as a Wi-Fi wireless access point. When base station 110 is implemented as a Wi-Fi wireless access point, the uplinks and downlinks between the wireless access point and the user equipment 114A-C may be implemented as links configured in accordance with, for example, Wi-Fi, WiGig, and any wireless local area network standard.

Although FIG. 1C depicts a single base station 110 (or wireless access point), two coverage areas 112A-B, and four user equipment 114A-D, other quantities of base stations/wireless access points, coverage areas, and user equipment may be implemented as well.

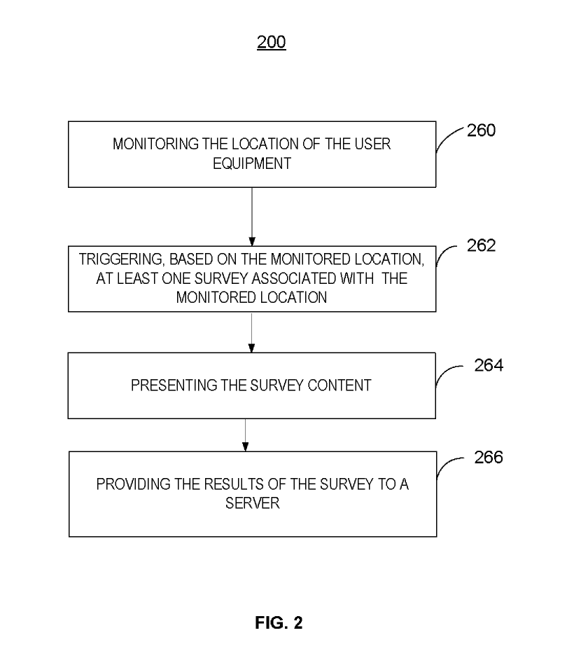

FIG. 2 depicts an example process 200 for presenting a survey based on location context in accordance with some exemplary embodiments. The process 200 may be implemented at user equipment, such as user equipment 114A-D. The description of process 200 also refers to FIGS. 1A and 1C.

At 260, the location of the user equipment may be monitored in some exemplary embodiments. For example, user equipment 114A may include a global positioning system (GPS) processor for generating location information, and this GPS processor may provide location data to other components of the user equipment. The user equipment 114A may receive location information from a location server in the network and/or simply determine the location based on the cell identifier. In any case, the user equipment may be able to make a determination of its location.

At 262, a survey may, in some exemplary embodiments, be triggered based on the monitored location. For example, the survey application 196A may monitor the location at 260, and when the monitored location corresponds to location information for a survey, the survey is triggered. Returning to the example of Table 1, survey application 196A may include survey identifier 001 and location information corresponding to cell identifier 36247169. When the monitored location corresponds to cell identifier 36247169, survey application 196A triggers the survey corresponding to survey identifier 001. In some exemplary embodiments, the survey application 196A may then request the contents of survey identifier 001 and when the contents are received, the survey application 196A may present, at 264, the question “Do you use BOTOX? If so, answer the survey to get a 10% discount at Clinic,” so that the survey contents are presented at the user interface of user equipment 114A. In some exemplary embodiments, the survey application 196A is pre-loaded with the contents “Do you use BOTOX? If so, answer the survey to get a 10% discount at Clinic X.” When this is the case, the survey application 196A can just present, at 264, the survey content without querying the survey server 190. For example, survey application 196A may generate a page, such as a hypertext markup language page, and present the survey content in a browser at a user interface of the user equipment. The survey application 196A may be included in a social networking application, in which case the survey application 196A presents the survey content within a page of a social networking web site.

At 266, the results of the survey may be provided to a server, such as the survey server 190. For example, the survey application 196A may send to survey server 190 any responses to the survey presented at the user interface of user equipment 114A. If the survey includes a link, the survey application 196A may include click through information and the like. The survey server 190 may then process the received results.

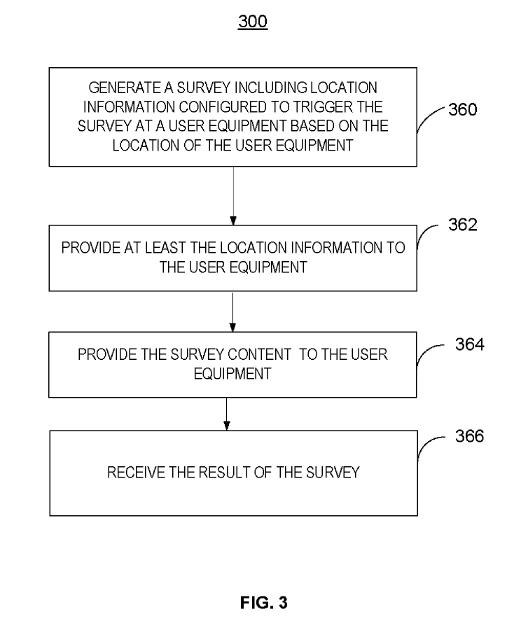

FIG. 3 depicts a process 300 for providing a survey based on location context in accordance with some exemplary embodiments. The process 300 may be implemented at a server, such as survey server 190. The description of process 300 also refers to FIGS. 1A and 1C.

At 360, a survey may, in some exemplary embodiments, be generated, and the survey may include location information configured to enable the survey to be triggered based on the location of a user equipment. For example, the survey server 190 may generate a survey including at least one of a survey identifier, survey content, and a location information. In some exemplary embodiments, the generated survey is stored at survey server 190, although the surveys may be stored in other locations as well. The survey content may include questions and may include rewards.

At 362, the location information for a survey may, in some exemplary embodiments, be provided to user equipment. The location information may be provided with at least one of a survey identifier and survey contents. For example, the survey server 190 may provide a survey identifier mapped to location information, and when the location is triggered at the user equipment, the survey server 190 may provide survey contents for the triggered survey. While in some embodiments, the survey server 190 may pre-load the user equipment/survey application with the survey identifier, the survey content, and the location information, so that the user equipment can present the survey without any further requests to survey server 190. In any case, the survey server 190 may provide, at 364, the survey contents to the user equipment 114A.

At 366, the results of the survey may be received in some exemplary embodiments. For example, the survey server 190 may receive any responses to the survey presented at the user interface of user equipment 114A. For example, if the answer to the survey “Do you use BOTOX?” is yes, the answer “yes” may be sent to the survey server 190.

In some exemplary embodiments, the user equipment 114A may register with the survey server 190. For example, a user may use the user equipment 114A to register at survey server 190. During the registration, the user may provide information, such as for example age, gender, interests, hobbies, profession, residential address, and/or other demographic information. The survey server 190 may then provide the registered user associated with the user equipment 114A and/or survey application 196A with one or more survey identifiers, each with a corresponding context (e.g., location information, a type of location, and the like). When the context (e.g., location information, type of location, and the like) of the user equipment 114A corresponds to a specific survey identifier, the survey server 190 may then send the survey contents.

For example, when the user is at, near, or in a location mapped to a context of hospital, the context “hospital” may trigger a survey identifier at the user equipment/survey application, in which case a request for the survey contents is sent to the survey server 190, which in turn responds with the triggered survey contents (which in this case is a survey for a hospital). Rather than send a survey based merely on location information, the survey server 190 can send a survey based on semantic information derived from its location (e.g., the more general context of hospital). For example, a first user equipment may be located near a hospital in NYC, and a second user equipment may be located near a hospital in Miami. In this example, although the first and second user equipment have different locations, the survey server 190 may serve the same survey as both the first and second user equipment have the same context derived from their actual locations.

Moreover, in some implementations, the survey application at the user equipment may monitor its location and send its context rather than a specific location to the survey server. For example, survey application may monitor its location and determine from map data (e.g., Google maps, Ovi maps, and the like) other semantic information, such as for example that the user equipment is near a hospital. In this example, the survey application may send its context (which in this example is hospital) to the survey sever 190, which responds with one or more surveys for the general context hospital. Here again, the survey server 190 can send survey content derived semantically from the location information, e.g., the context of hospital.

To further illustrate by way of another example, when the user is at, near, or in a location mapped to a context of a park, a stadium, a shopping mall, a post office, a school, a cinema, a restaurant, and the like, the context of the user equipment may trigger a corresponding survey identifier at the user equipment/survey application. The equipment/survey application may then request from the survey server the survey content for the triggered survey identifier, and then the survey server responds with the triggered survey content (e.g., survey contents for a park, a stadium, a shopping mall, a post office, a school, a cinema, and/or a restaurant). In these examples, the survey server may target specific recipients for the surveys based on context.

Moreover, if the context is triggered in anticipation of a specific context, the survey contents can be delivered predictably. For example, when the user is approaching the location mapped to the context of hospital, the survey server 190 may respond with the triggered survey contents before the user equipment is at the hospital.

The subject matter described herein may be configured, in some exemplary embodiments, to implement two-stage survey serving. For example, in the first stage, the survey server 190 may provide to the user equipment/survey application one or more triggers based on context (e.g., survey identifiers and/or location information), and in the second stage, the survey server 190 responds with the actual survey contents based on a request from the user equipment/survey application triggered by the context. The use of the two-stage survey serving may, in some implementations, reduce accesses to the survey server 190, save data usage, and/or power consumption at the user equipment, when compared to a one stage approach which sends a plurality of surveys without regard to context.

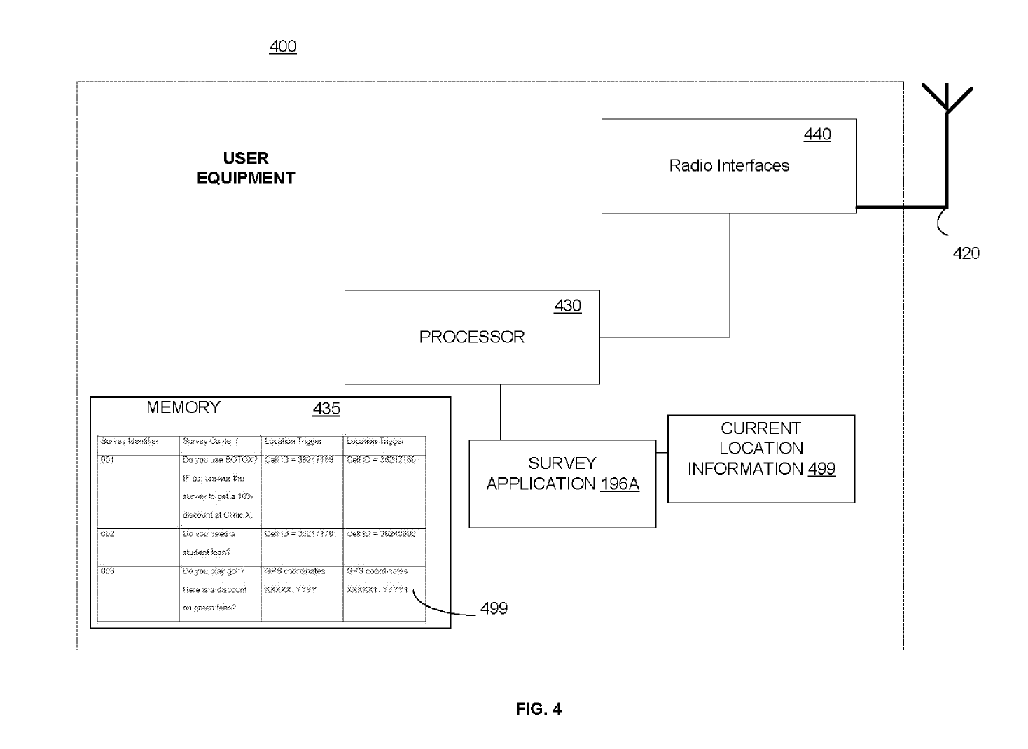

FIG. 4 depicts an exemplary user equipment 400, which may be implemented at one or more of user equipment 114A-D. The user equipment may include one or more antennas 420 coupled to radio interface 440. The radio interface 440 may include one or more interfaces to other devices and/or networks, such as internet access provided via wireless access points, cellular networks including base stations, and the like. The radio interface 440 may include other components, such as filters, converters (e.g., digital-to-analog converters and the like), symbol demappers, transforms, and the like. The user equipment may further include at least one processor, such as a processor 430 for controlling the user equipment and for accessing and executing program code stored in memory 435. Furthermore, the user equipment may include a survey application 196A configured to provide one or more aspects of the mechanisms and processes described herein including process 200. Moreover, user equipment 400 may include current location information 499 representing the current location of user equipment 400 as determined from the cell identifier, global positioning information, and/or any other source of location information. The memory 435 may also include one or more of the following provided by server survey 190: survey identifiers, survey content, location information, and the like.

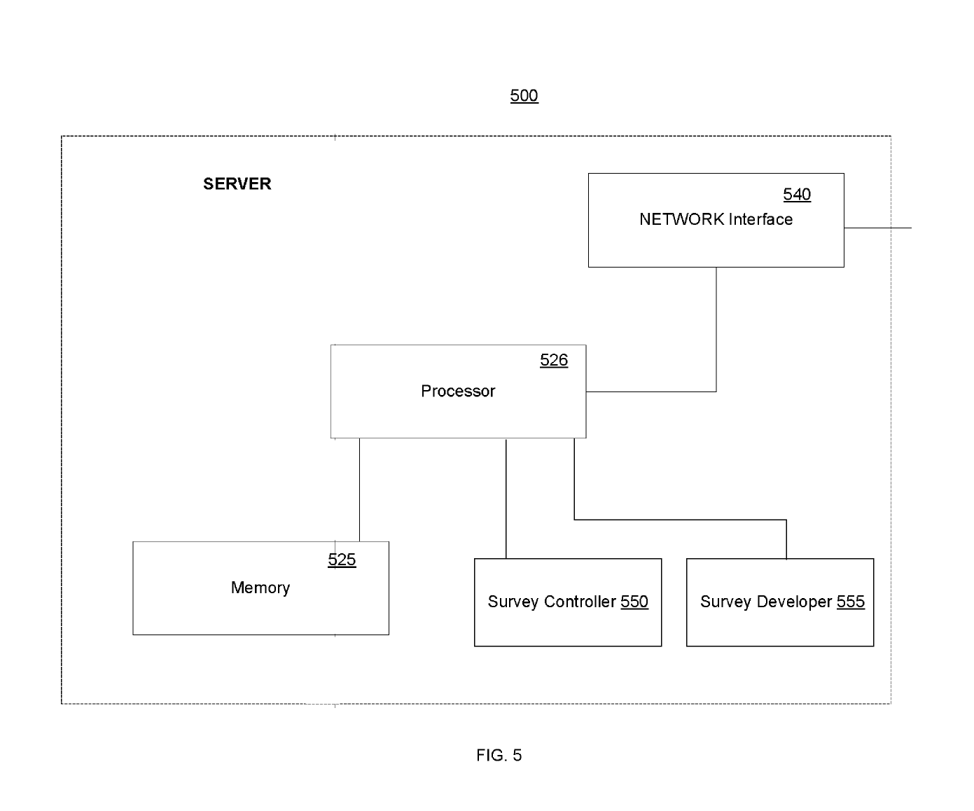

FIG. 5 depicts an example implementation of a server 500, which may be implemented at survey server 190. The server 500 may include a network interface 540 for accessing the internet, other servers, and/or base station/wireless access point 110. The server 500 may further includes a processor 526 for controlling the server and for accessing and executing program code stored in memory 525. Furthermore, the server 500 may include a survey controller 550 for serving the surveys described herein including survey identifiers, location information, and the like. The server 500 may also include a developer 555 to enable development of surveys. In some exemplary embodiments, the survey controller 550 may perform one or more of the survey related mechanisms described herein including. In addition to code, the memory 525 may include, as depicted at FIG. 5, surveys, survey identifiers, survey content, location information, and the like.

The subject matter described herein may be embodied in systems, apparatus, methods, and/or articles depending on the desired configuration. For example, the user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. For example, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. The phrases “based on” and “based on at least” are used interchangeably herein. In various example embodiments, the methods (or processes) can be accomplished on user equipment/mobile device side or on the server side or in any shared way between server and user equipment/mobile device with actions being performed on both sides. Other embodiments may be within the scope of the following claims.

1-28. (canceled)

29. A method comprising:
monitoring a location of a user equipment of a public land mobile network to determine when the monitored location corresponds to a survey trigger corresponding to a survey served by a server;
sending to the server a request for content of the survey, when the monitored location corresponds to the survey trigger; and
receiving, in response to the request, the content of the survey selected in accordance with a context derived from at least the monitored location.

30. The method of claim 29 further comprising:
presenting, at the user equipment, the received content of the survey corresponding to the context.

31. A method of claim 29, wherein the survey trigger comprises at least one of a survey identifier and the location.

32. A method of claim 29 further comprising:
receiving, at the user equipment, a plurality of survey triggers representative of locations to be monitored by the user equipment.

33. A method of claim 29 further comprising:
storing, at the user equipment, a plurality of survey triggers representative of locations to be monitored by the user equipment.

34. A method of claim 29, wherein the sending further comprises:
sending, by the user equipment, the request for the content of the survey, when the monitored location is at least one of at or near the location mapped to the survey trigger.

35. A method of claim 29, wherein the sending further comprises:
sending, by the user equipment, the request comprising at least one of the survey trigger, a survey identifier, and the monitored location of the user equipment.

36. A method of claim 29 further comprising:
determining semantically the context of the user equipment based on at least the monitored location of the user equipment.

37. A method of claim 29, wherein the content comprises at least one of a question and a reward.

38. A method of claim 29 further comprising:
registering the user equipment with the server to obtain surveys based on the context of the user equipment.

39. A method of claim 29, wherein the monitoring further comprises:
receiving, at the user equipment, information representative of the location of the user equipment.

40. An apparatus comprising:
at least one processor; and
at least one memory including code which when executed by the at least one processor provides operations comprising:
monitoring a location of the apparatus comprising a user equipment of a public land mobile network to determine when the monitored location corresponds to a survey trigger corresponding to a survey served by a server;
sending to the server a request for content of the survey, when the monitored location corresponds to the survey trigger; and
receiving, in response to the request, the content of the survey selected in accordance with a context derived from at least the monitored location.

41. An apparatus of claim 40 further comprising:
presenting, at the user equipment, the received content of the survey corresponding to the context.

42. An apparatus of claim 40, wherein the survey trigger comprises at least one of a survey identifier and the location.

43. An apparatus of claim 40 further comprising:
receiving, at the user equipment, a plurality of survey triggers representative of locations to be monitored by the user equipment.

44. An apparatus of claim 40 further comprising:
storing, at the user equipment, a plurality of survey triggers representative of locations to be monitored by the user equipment.

45. An apparatus of claim 40, wherein the sending further comprises:
sending, by the user equipment, the request for the content of the survey, when the monitored location is at least one of at or near the location mapped to the survey trigger.

46. An apparatus of claim 40, wherein the sending further comprises:
sending, by the user equipment, the request comprising at least one of the survey trigger, a survey identifier, and the monitored location of the user equipment.

47. An apparatus of claim 40 further comprising:
determining semantically the context of the user equipment based on at least the monitored location of the user equipment.

48. An apparatus of claim 40, wherein the content comprises at least one of a question and a reward.

49. An apparatus of claim 40 further comprising:
registering the user equipment with the server to obtain surveys based on the context of the user equipment.

50. An apparatus of claim 40, wherein the monitoring further comprises:
receiving, at the user equipment, information representative of the location of the user equipment.
